(19) United States
(12) Patent Application Publication
(10) Pub. No.: US 2011/0043111 A1
(43) Pub. Date: Feb. 24, 2011

(54) RF FEED CONFIGURATIONS AND ASSEMBLY FOR PLASMA LAMP

(76) Inventors: Gregg Hollingsworth, Tempe, AZ (US); Marc DeVincentis, Palo Alto, CA (US); Jae Won Kim, San Jose, CA (US)

Correspondence Address: SCHWEGMAN, LUNDBERG & WOESSNER, P.A., P.O. BOX 2938, MINNEAPOLIS, MN, 55402, US

(21) Appl. No.: 12/445,693

(22) PCT Filed: Oct. 16, 2007
(86) PCT No.: PCT/US07/81541

§ 371 Date: Nov. 11, 2010

Related U.S. Application Data
(60) Provisional application No. 60/852,292, filed on Oct. 16, 2006.

(51) Int. Cl. H01J 7/44

(52) U.S. Cl. 315/32

(57) ABSTRACT

Systems and methods for lamp assembly and connection of radio frequency feeds to lamp body are described. In an example embodiment, a circuit board is positioned transverse to a lamp body and one or more radio frequency probes extend from the edge of the circuit board into the lamp body. In another embodiment, portions of a circuit board may form traces that extend into a lamp body. In other embodiments, radio frequency probes may extend from the front surface or back surface of a circuit board into a lamp body. A lamp housing may provide a support, ground and heat sink for lamp components.

### CROSS REFERENCE TO RELATED APPLICATIONS

This application claims the benefit of priority of U.S. Provisional Application No. 60/852,292, entitled “RF FEED CONFIGURATIONS AND ASSEMBLY FOR PLASMA LAMP,” filed on Oct. 16, 2006. The entire contents of which are incorporated herein by reference.

### BACKGROUND

I. Field

The field relates to systems and methods for generating light, and more particularly to electrodeless plasma lamps.

II. Background

Electrodeless plasma lamps may be used to provide bright, white light sources. Because electrodes are not used, they may have longer useful lifetimes than other lamps. In an electrodeless plasma lamp, radio frequency power may be coupled into a fill in a bulb to create a light emitting plasma. In order to make the lamp suitable for integration into a display system such as a television or a projector, it is desirable for the lamp to be compact and have low loss from the RF power source to the load.

What is desired are improved systems and methods for coupling an RF power source to an electrodeless plasma lamp. What is also desired are improved systems and methods for mounting and grounding a lamp body and circuit board for an electrodeless plasma lamp. What is also desired are a compact and low cost assembly for an electrodeless plasma lamp.

### SUMMARY

In one embodiment, a circuit board or other substrate is positioned transverse to a lamp body. In one embodiment, the plane of the circuit board substantially bisects the lamp body. In example embodiments, a radio frequency (RF) feed or other circuitry may extend from the edge of the board or other substrate into the lamp body. In example embodiments, one or more RF probes may extend parallel from the circuit board or other substrate into the lamp body. In example embodiments, the RF probes may be used to provide RF power to the lamp body or to obtain feedback from the lamp body.

In example embodiments, an electrically conductive housing may be used to support the circuit board or other substrate. In example embodiments, the base may be metal and provide a ground and heat sink for the lamp. In example embodiments, the ground plane of the circuit board may be grounded to the housing. In example embodiments, the lamp body has an electrically conductive coating that is also grounded to the housing.

In example embodiments, the housing provides a region for supporting a circuit board or other substrate and an adjacent region for receiving a lamp body. In example embodiments, another region is also provided for receiving a lens housing. In example embodiments, the housing has a metal base with a substantially planar region for receiving the circuit board or other substrate. In example embodiments, a recessed region is provided in the base adjacent to the planar region to receive a lamp body. In one example embodiment, the lamp body has an outer cylindrical surface and the recess in the base is semi-cylindrical and is shaped to receive about half of the lamp body. In this example, the housing has a cover shaped to enclose the other half of the lamp body. In this example, the diameter of the outer cylindrical shape formed by the lamp body is substantially orthogonal to the plane of the circuit board. In another example, the outer surface of the lamp body forms a rectangular shape and the base and cover of the housing are shaped to receive the rectangular shape formed by the outer surface of the lamp body. In example embodiments, the base and cover are also shaped to receive a lens housing adjacent to the lamp body. In one example, the lens housing is on the opposite side of the lamp body from the circuit board. In one example, the lens housing has an outer surface that is substantially cylindrical, and the base of the lamp housing is shaped to receive about half of the lens housing and the cover of the lamp housing is shaped to cover the other half of the lens housing. In one example, the lamp housing forms at least one ridge or groove for aligning the lamp body and/or lens housing. In one example, a bulb protrudes from a front surface of the lamp body and provides light to one or more lenses in the lens housing.

In example embodiments, one or more radio frequency feeds are coupled directly to a circuit board or substrate without requiring separate connectors. In another aspect, one or more radio frequency feeds are surrounded by a ceramic sleeve in the lamp body. In an alternative embodiment, the RF feeds extend into the lamp body without a sleeve.

In another embodiment, one or more RF feeds are provided by a trace on a circuit board or other substrate. In example embodiments, portions of a circuit board or other substrate extend directly into a lamp body. In an example embodiment, at least one circuit trace provides a drive probe for the lamp and another circuit trace provides a feedback probe for the lamp. In example embodiments, the trace for the feedback probe is shorter than the trace for the drive probe.

In another embodiment, a lamp body is positioned with an RF feed transverse to the plane of a circuit board or other substrate. In an example embodiment, a portion of an electrically conductive base is positioned between the lamp body and the circuit board. In this example, the lamp body has an electrically conductive coating that is electrically grounded to the portion of the base between the lamp body and the circuit board. In this example, an opening is formed through this portion of the base and the probe is mounted to a front surface of the circuit board through the opening. In example embodiments, an RF feed extends from a front surface of a circuit board or other substrate in a direction substantially orthogonal to the plane of the circuit board or other substrate.

In another embodiment, an RF feed is connected to circuitry on a front surface of a circuit board or other substrate and extends through an opening in the circuit board or other substrate and out the back surface of circuit board or other substrate. In example embodiments, the lamp body has an electrically conductive surface that is grounded to the ground plane of the circuit board or other substrate and/or to a base of a housing supporting the circuit board or other substrate. The lamp body is positioned adjacent to the back side of the lamp body in this example.

It is understood that each of the above aspects of example embodiments may be used alone or in combination with other aspects described above or in the detailed description below. A more complete understanding of example embodiments and other aspects and advantages thereof will be gained from a consideration of the following description read in conjunction with the accompanying drawing figures provided herein. In the figures and description, numerals indicate the various features of example embodiments, like numerals referring to like features throughout both the drawings and description.

### BRIEF DESCRIPTION OF THE DRAWINGS

FIG. 1A is a cross-section and schematic view of a plasma lamp according to an example embodiment.

FIG. 1B is a perspective cross section view of a lamp body with a cylindrical outer surface according to an example embodiment.

FIG. 1C is a perspective cross section view of a lamp body with a rectangular outer surface according to an alternative example embodiment.

FIG. 2A is a side cross section of a lamp with a circuit board defining a plane that intersects the lamp body and an RF feed extending parallel from the circuit board into the lamp body according to an example embodiment.

FIG. 2B is a side cross section of a lamp with a circuit board defining a plane that intersects the lamp body and an RF feed extending parallel from the circuit board into the lamp body according to another example embodiment.

FIG. 3A is a top perspective view of the base of a lamp housing supporting a circuit board, lamp body and lens housing according to an example embodiment.

FIG. 3B is a top perspective view of the base and cover of a lamp housing.

FIG. 3C is a side view of a lamp housing and lens assembly according to an example embodiment.

FIG. 3D is a top perspective view of an assembled lamp according to an example embodiment.

FIG. 4A is a side cross section of a lamp with a circuit board that includes portions that extend into a lamp body according to an example embodiment.

FIG. 4B is a top cross section of a lamp with drive probe and feedback probe formed by circuit board traces that extend into a lamp body according to an example embodiment.

FIG. 5A is a side cross section of a lamp with an RF feed extending from the front surface of a circuit board into a lamp body according to an example embodiment.

FIG. 5B is a side cross section of a lamp with an RF feed extending from the back surface of a circuit board into a lamp body according to an example embodiment.

### DETAILED DESCRIPTION

While the present invention is open to various modifications and alternative constructions, the embodiments shown in the drawings will be described herein in detail. It is to be understood, however, there is no intention to limit the invention to the particular forms disclosed. On the contrary, it is intended that the invention cover all modifications, equivalences and alternative constructions falling within the spirit and scope of the invention as expressed in the appended claims.

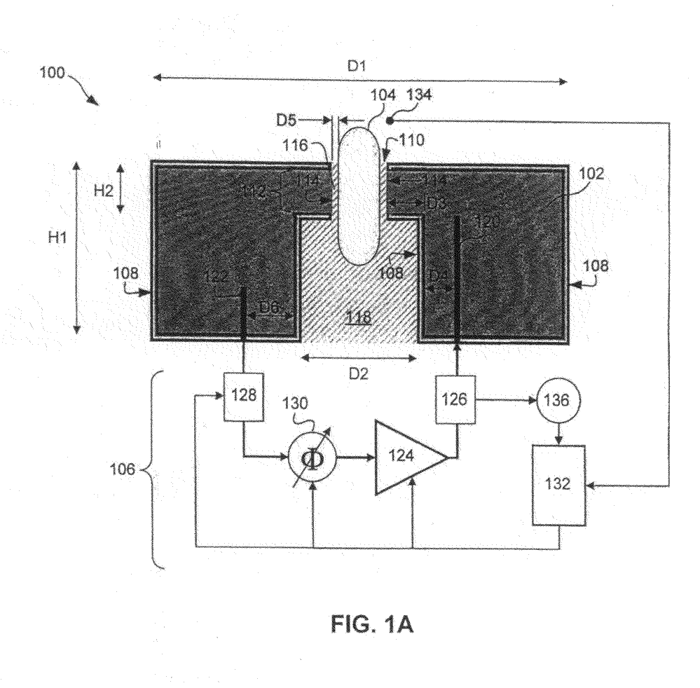

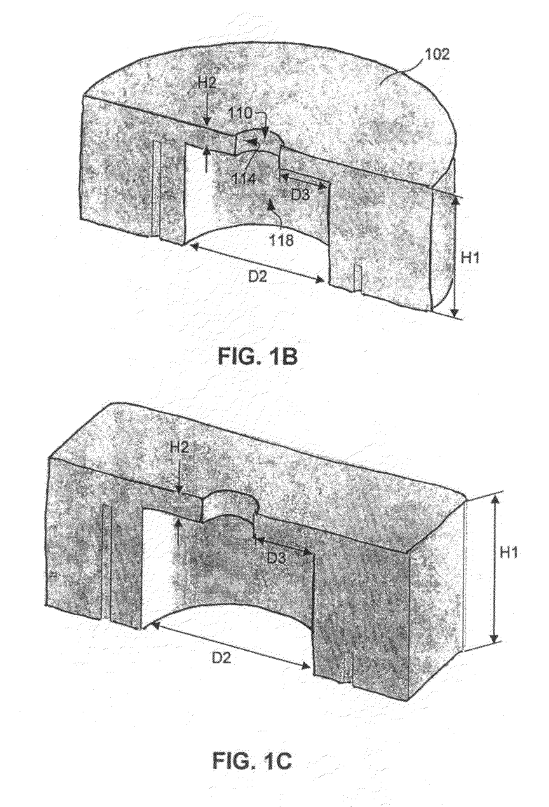

FIG. 1A is a cross-section and schematic view of a plasma lamp 100 according to an example embodiment. In example embodiments, the plasma lamp may have a lamp body 102 formed from one or more solid dielectric materials and a bulb 104 positioned adjacent to the lamp body. The bulb contains a fill that is capable of forming a light emitting plasma. A lamp drive circuit 106 couples radio frequency power into the lamp body 102 which, in turn, is coupled into the fill in the bulb 104 to form the light emitting plasma. In example embodiments, the lamp body 102 forms a waveguide that contains and guides the radio frequency power. In example embodiments, the radio frequency power may be provided at or near a frequency that resonates within the lamp body 102.

Lamp 100 has a drive probe 120 inserted into the lamp body 102 to provide radio frequency power to the lamp body 102. In the example of FIG. 1A, the lamp also has a feedback probe 122 inserted into the lamp body 102 to sample power from the lamp body 102 and provide it as feedback to the lamp drive circuit 106. A lamp drive circuit 106 including a power supply, such as amplifier 124, may be coupled to the drive probe 120 to provide the radio frequency power.

In example embodiments, radio frequency power may be provided at a frequency in the range of between about 50 MHz and about 10 GHz or any range subsumed therein. The radio frequency power may be provided to drive probe 120 at or'near a resonant frequency for lamp body 102. The frequency may be selected based on the dimensions, shape and relative permittivity of the lamp body 102 to provide resonance in the lamp body 102. In example embodiments, the frequency is selected for a fundamental resonant mode of the lamp body 102, although higher order modes may also be used in some embodiments. In example embodiments, the RF power may be applied at a resonant frequency or in a range of from 0% to 10% above or below the resonant frequency or any range subsumed therein. In some embodiments, RF power may be applied in a range of from 0% to 5% above or below the resonant frequency. In some embodiments, power may be provided at one or more frequencies within the range of about 0 to 50 MHz above or below the resonant frequency or any range subsumed therein. In another example, the power may be provided at one or more frequencies within the resonant bandwidth for at least one resonant mode. The resonant bandwidth is the full frequency width at half maximum of power on either side of the resonant frequency (on a plot of frequency versus power for the resonant cavity).

In example embodiments, the radio frequency power causes a light emitting plasma discharge in the bulb. In example embodiments, power is provided by RF wave coupling. In example embodiments, RF power is coupled at a frequency that forms a standing wave in the lamp body (sometimes referred to as a sustained waveform discharge or microwave discharge when using microwave frequencies). In other embodiments, a capacitively coupled or inductively coupled electrodeless plasma lamp may be used. Other high intensity discharge lamps may be used in other embodiments.

While a variety of shapes may be used, one example embodiment has a lamp body 102 with a cylindrical outer surface as shown in FIG. 1B and a recess 118 formed in the bottom surface. In an alternative embodiment shown in FIG. 1C, the lamp body 102 may have a rectangular outer surface.

In example embodiments, a circuit board or other substrate for lamp drive circuit 106 may be positioned transverse to the lamp body 102 and one or more radio frequency (RF) feeds or other circuitry or electronics may extend from the board or other substrate into the lamp body.

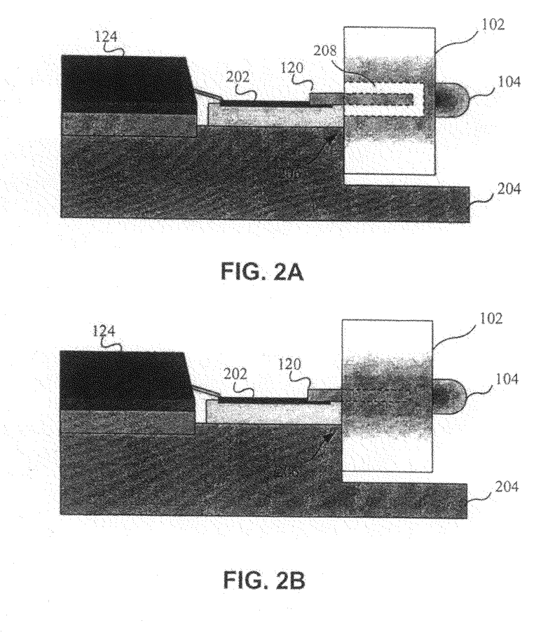

FIG. 2A is a side cross section of a lamp showing one example embodiment of a lamp assembly for lamp 100 where RF probes extend from a circuit board into the lamp body 102. The lamp includes an electrically conductive base 204 for supporting the components of lamp 100. The base may be aluminum or other metal and may provide a ground for the lamp. The base 204 supports an RF power amplifier module 124 and a circuit board 202 or other substrate for the other components of lamp drive circuit 106. In this example, the drive probe 120 is mounted directly to the circuit board 202 and extends into lamp body 102. Similarly, feedback probe 122 (not shown in FIG. 2A) may be mounted directly to the circuit board 202 and extend into lamp body 102. In this example, a sleeve 208 of ceramic or other material is formed around the probe 120 and inserted into lamp body 102. In example embodiments, the probes may be soldered directly to the circuitry on the circuit board 202 without requiring separate connectors.

As shown in FIG. 2A, the circuit board 202 defines a plane that intersects lamp body 102. In this example, the outer surface of the lamp body is cylindrical and has a diameter that is substantially orthogonal to the plane of circuit board 202. In other examples, the outer surface of the lamp body is rectangular (as shown in FIG. 1C) and has a width that is substantially orthogonal to the plane of circuit board 202. Drive probe 120 and feedback probe 122 (not shown in FIG. 2A) are substantially parallel to the plane of the circuit board 202. Bulb 104 is also substantially parallel to the plane of the circuit board 202 and projects light from the front surface of the lamp body 102 on the opposite side of the lamp body from the circuit board 202. In this example, light is projected from bulb 104 both above and below the plane defined by circuit board 202.

In the example shown in FIG. 2A, the plane of circuit board 202 substantially bisects the lamp body 102, with about half of the lamp body extending below the front surface of the circuit board and about half of the lamp body extending above the front surface of the circuit board. In the example shown in FIG. 2A, the center of the drive probe 120 and feedback probe 122 are positioned at a diameter that bisects the lamp body and the front surface of the circuit board 202 is offset by one half the diameter of the probe. In one example, the diameter of the probes is about 2 mm and the circuit board offset is offset from the center diameter by about 1 mm. In some example embodiments, the lamp body has a recess 118 and the circuit board 202 is positioned transverse to the recess 118.

In FIG. 2A, the circuit board has a ground plane that is grounded to base 204. Base 204 may be aluminum or other metal and may provide both a ground and heat sink for the lamp. Lamp body 102 has an electrically conductive coating on its outer surface and may be grounded to the base 204 and/or ground plane of the circuit board as indicated at 206.

FIG. 2B is a side cross section of a lamp showing another example embodiment of a lamp assembly for lamp 100. This assembly uses the same configuration as FIG. 2A, except that a ceramic sleeve is not formed around the probes. Instead, the drive probe 120 and feedback probe 122 may be positioned in direct contact with lamp body 102. In example embodiments, the probes may be glued directly to lamp body 102 using silver paint.

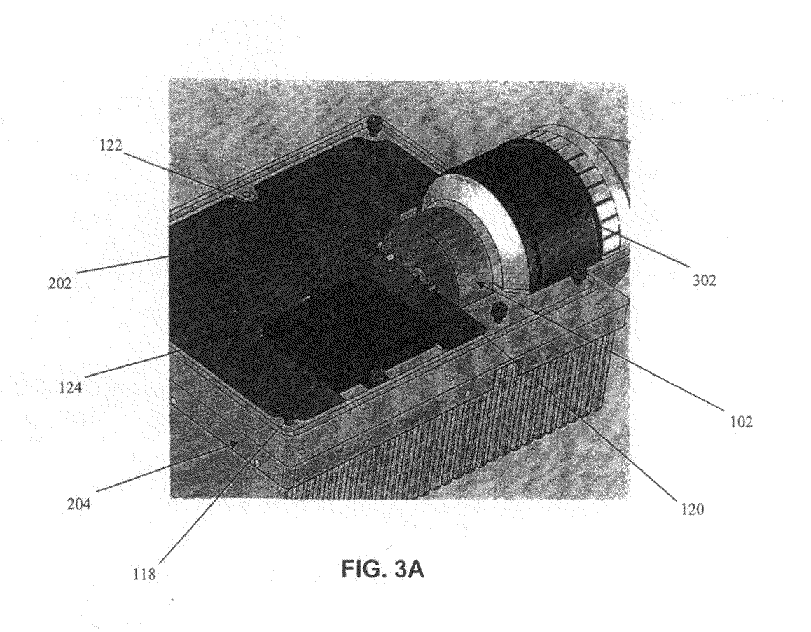

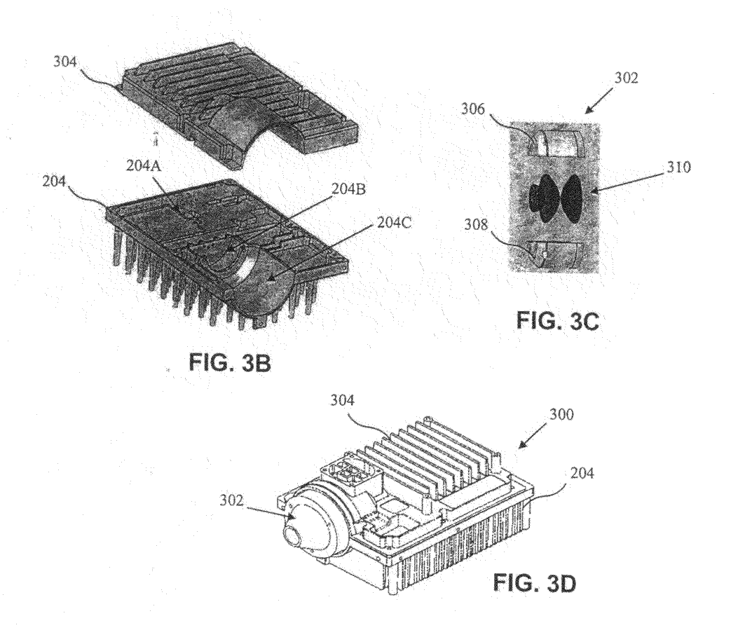

FIG. 3A is a top perspective view of the base 204 of a lamp housing supporting RF power amplifier 124, circuit board 202, lamp body 102 and a lens housing 302 according to an example embodiment. FIG. 3B is a top perspective view of the base 204 of the lamp housing and the cover 304 for the lamp housing. FIG. 3C is a side view of an unassembled lens housing 302 that, when assembled, is received within the lamp housing. FIG. 3D is a top perspective view of the assembled lamp housing with base 204, cover 304 and lens housing 302.

The base and cover of the housing may be aluminum or other metal and provide a ground and heat sink for the lamp. As shown in FIG. 3A, the drive probe 120 and feedback probe 122 may extend directly from the front edge of the circuit board 202 into the lamp body 102. The circuit board 202 is substantially aligned with a diameter of lamp body 102 and is transverse to recess 118. As shown in FIG. 3B, the base 204 of the housing provides a substantially planer region 204A for supporting the circuit board 202 and an adjacent recessed region 204B for receiving a lamp body. In example embodiments, another recessed region 204C is also provided for receiving the lens housing 302. In one example embodiment, the lamp body 102 has an outer cylindrical surface and the recessed region 204B in the base is semi-cylindrical and is shaped to receive about half of the lamp body. In this example, the cover 304 also has a recessed region shaped to enclose the other half of the lamp body. In another example, the outer surface of the lamp body forms a rectangular shape and the base and cover of the housing is shaped to receive the rectangular shape formed by the outer surface of the lamp body. In example embodiments, the base has another semi-cylindrical recessed region 204C to receive half of the lens housing 302 adjacent to the lamp body and the cover has a semi-cylindrical recessed region to cover the other half of the lens housing 302. In one example, the lens housing 302 is positioned on the opposite side of the lamp body 102 from the circuit board 202 and light is projected through the lens housing out of the lamp. In one example, the housing forms at least one ridge or groove for aligning the lamp body and/or lens housing.

FIG. 3C is a side view of a lamp housing and lens assembly according to an example embodiment. As shown in FIG. 3C, the lamp housing 302 has a top cover 306 and bottom cover 308. The covers enclose a lens assembly 310, which is a lens triplet in this example. This is an example only and other lens assemblies may be used in other embodiments. A cover plate, grooves, ridges, pins or other structures may be formed on or be attached to the front of the lamp housing 300 or lens assembly 302 to facilitate alignment and mounting to other components of a projection display system or other system using the lamp.

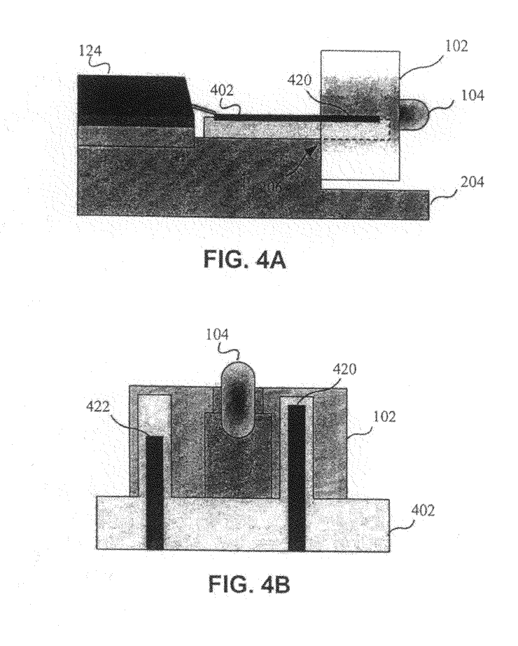

FIG. 4A is a side cross section of a lamp according to an alternate embodiment with a circuit board 402 or other substrate that includes portions that extend into a lamp body. For example, a circuit trace on the board 402 may extend into the lamp body to form a drive probe or feedback probe. As shown in FIG. 4A, the circuit board 402 extends into lamp body 102 to form drive probe 420. The drive probe 420 is formed from a trace on the portion of the circuit board that extends into lamp body 102. Similarly, a feedback probe may be formed by a trace of the circuit board on a portion of the circuit board that extends into the lamp body 102. FIG. 4B is a top cross section of a lamp showing a drive probe 420 and feedback probe 422 formed by circuit board traces that extend into the lamp body. In this example, the circuit trace for the drive probe 420 is longer and provides stronger coupling to the lamp body than the circuit trace for the feedback probe 422. The rest of the lamp configuration in FIGS. 4A and 4B is similar to the lamp configuration described in FIGS. 3A and 3B. The base 204 supports an amplifier 124, circuit board 402 and lamp body 102. A lens housing may also be used as described above. The circuit board 402 is transverse to the lamp body and defines a plane that bisects the lamp body. The ground plane and electrically conductive coating on the lamp body 102 may be grounded to the base 204 as indicated at 206. The lamp shown in FIGS. 4A and 4B may be enclosed in a housing 300 with a lens assembly as described above in connection with FIGS. 3A, 3B, 3C, and 3D above.

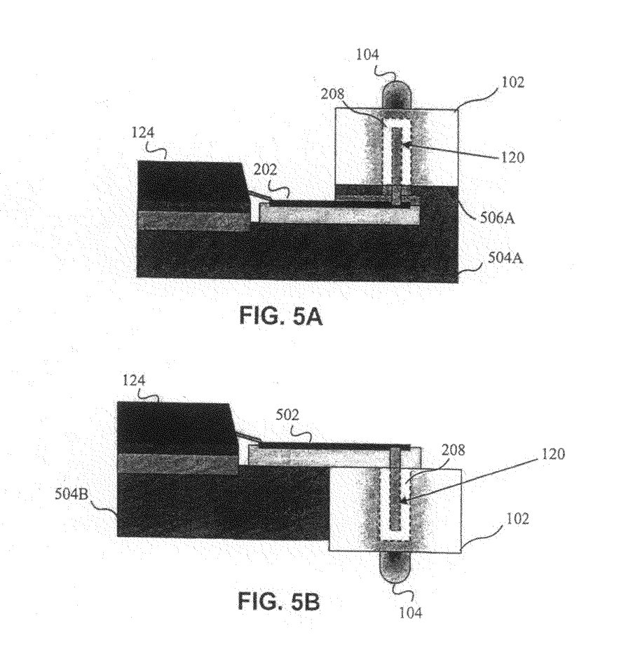

FIG. 5A is a side cross section of a lamp with drive probe 120 extending from the front surface of circuit board 202 into lamp body 102 according to an example embodiment. Similarly, feedback probe 122 (not shown in FIG. 5A) may extend from the front surface of circuit board 202 into lamp body 102. The probes may be soldered directly to traces on the circuit board 202. As in the examples described above, a metal base 504A may be used to support an amplifier 124, circuit board 202 and lamp body 102. A lens housing may also be positioned in front of lamp body 102 and may be supported by a cover for the lamp housing in this embodiment. In this example, a portion 506A of the base 504A extends between the circuit board 202 and the lamp body 102 to provide a ground and heat sink. The electrically conductive coating on the lamp body 102 may be grounded to this portion 506A of the base 504A. The ground plane of the circuit board may also be grounded to base 504A. An opening may be formed in the portion 506A of the base 504A to allow the probe 120 to pass through the opening to the circuit board 202 and is spaced apart from the portion 506A of the base 504A. Similarly, another opening may be formed in portion 506A to allow a feedback probe 122 to pass through to the circuit board 202. In this example, a ceramic sleeve 208 is used around the probe and may be used to keep the probe spaced apart and electrically insulated from the portion 506A of the base. Other embodiments may not use a sleeve around the probe. In this example, the probes are transverse to the plane of the circuit board and may be substantially orthogonal to the plane of the circuit board 202. This embodiment may also use a lamp housing and lens housing similar to those described above, except that the region for receiving the lamp body and lens housing are formed in the cover of the lamp housing and light is projected from the top of the lamp (in a direction away from the front surface of the circuit board).

FIG. 5B is a side cross section of a lamp with drive probe 120 extending from the back of a circuit board 502 into the lamp body 102 according to an example embodiment. Similarly, feedback probe 122 (not shown in FIG. 5B) may extend from the back of circuit board 502 into lamp body 102. The probes may be soldered directly to traces on the front of circuit board 502. As in the examples described above, a metal base 504B may be used to support an amplifier 124, circuit board 502 and lamp body 102. A lens housing may also be positioned in front of lamp body 102 and base 504B may extend around the lamp body and lens housing to provide support or a separate enclosure may be used for the lens housing. In this example, an opening is formed in the circuit board 502 to allow the drive probe to extend from a trace on the front of circuit board 502, through the circuit board and out the back of the circuit board into the lamp body 102. Similarly, another opening may be formed in the circuit board 502 to allow a feedback probe 122 (not shown in FIG. 5B) to pass through the circuit board into the lamp body 102. In this example, a ceramic sleeve 208 is used around the drive probe (and may also be used around the feedback probe). Other embodiments may not use a sleeve around the probes. The ground plane of the circuit board 502 and/or the electrically conductive coating on the lamp body 102 may be grounded to the base 504B as shown at 506B. In this example, the probes are transverse to the plane of a circuit board and may be substantially orthogonal to the plane of the circuit board 502. This embodiment may also use a lamp housing and lens housing similar to those described above, except that the region for receiving the lamp body and lens housing are formed in the base of the lamp housing and light is projected from the bottom of the lamp (in a direction away from the back surface of the circuit board).

Additional aspects of an example lamp 100 that may be used in the above embodiments will now be described with reference to FIGS. 1A, 1B and 1C. In example embodiments, the lamp body 102 has a relative permittivity greater than air. The frequency required to excite a particular resonant mode in the lamp body 102 generally scales inversely to the square root of the relative permittivity (also referred to as the dielectric constant) of the lamp body. As a result, a higher relative permittivity results in a smaller lamp body required for a particular resonant mode at a given frequency of power. The shape and dimensions of the lamp body 102 also affect the resonant frequency as described further below. In an example embodiment, the lamp body 102 is formed from solid alumina having a relative permittivity of about 9.2. In some embodiments, the dielectric material may have a relative permittivity in the range of from 2 to 100 or any range subsumed therein, or an even higher relative permittivity. In some embodiments, the body may include more than one such dielectric material resulting in an effective relative permittivity for the body within any of the ranges described above. The body may be rectangular, cylindrical or other shape as described further below.

In example embodiments, the outer surfaces of the lamp body 102 may be coated with an electrically conductive coating 108, such as electroplating or a silver paint or other metallic paint which may be fired onto the outer surface of the lamp body. The electrically conductive material 108 may be grounded to form a boundary condition for the radio frequency power applied to the lamp body 102. The electrically conductive coating helps contain the radio frequency power in the lamp body. Regions of the lamp body may remain uncoated to allow power to be transferred to or from the lamp body. For example, the bulb 104 may be positioned adjacent to an uncoated portion of the lamp body to receive radio frequency power from the lamp body.

In the example embodiment of FIG. 1A, an opening 110 extends through a thin region 112 of the lamp body 102. The surfaces 114 of the lamp body 102 in the opening 110 are uncoated and at least a portion of the bulb 104 may be positioned in the opening 110 to receive power from the lamp body 102. In example embodiments, the thickness H2 of the thin region 112 may range from 1 mm to 10 mm or any range subsumed therein and may be less than the outside length and/or interior length of the bulb. One or both ends of the bulb 104 may protrude from the opening 110 and extend beyond the electrically conductive coating 108 on the outer surface of the lamp body. This helps avoid damage to the ends of the bulbs from the high intensity plasma formed adjacent to the region where power is coupled from the lamp body. In other embodiments, all or a portion of the bulb may be positioned in a cavity extending from an opening on the outer surface of the lamp body and terminating in the lamp body. In other embodiments, the bulb may be positioned adjacent to an uncoated outer surface of the lamp body or in a shallow recess formed on the outer surface of the waveguide body. In some example embodiments, the bulb may be positioned at or near an electric field maxima for the resonant mode excited in the lamp body.

The bulb 104 may be quartz, sapphire, ceramic or other desired bulb material and may be cylindrical, pill shaped, spherical or other desired shape. In one example embodiment, the bulb is cylindrical in the center and forms a hemisphere at each end. In one example, the outer length (from tip to tip) is about 15 mm and the outer diameter (at the center) is about 5 mm. In this example, the interior of the bulb (which contains the fill) has an interior length of about 9 mm and an interior diameter (at the center) of about 2.2 mm. The wall thickness is about 1.4 mm along the sides of the cylindrical portion and about 2.25 mm at the front end and about 3.75 mm on the other end. In this example, the bulb volume is about 31.42 mm³. In other example embodiments, the bulb may have an interior width or diameter in a range between about 2 and 30 mm or any range subsumed therein, a wall thickness in a range between about 0.5 and 4 mm or any range subsumed therein, and an interior length between about 2 and 30 mm or any range subsumed therein. In example embodiments, the volume may range from 10 mm³ and 750 mm³ or any range subsumed therein. These dimensions are examples only and other embodiments may use bulbs having different dimensions.

In example embodiments, the bulb 104 contains a fill that forms a light emitting plasma when radio frequency power is received from the lamp body 102. The fill may include a noble gas and a metal halide. Additives such as Mercury may also be used. An ignition enhancer may also be used. A small amount of an inert radioactive emitter such as Kr₈₅ may be used for this purpose.

In other embodiments, different fills such as Sulfur, Selenium or Tellurium may also be used. In some examples, a metal halide such as Cesium Bromide may be added to stabilize a discharge of Sulfur, Selenium or Tellurium.

In some example embodiments, a high pressure fill is used to increase the resistance of the gas at startup. This can be used to decrease the overall startup time required to reach full brightness for steady state operation. In one example, a noble gas such as Neon, Argon, Krypton or Xenon is provided at high pressures between 200 Torr to 3000 Torr or any range subsumed therein. Pressures less than or equal to 760 Torr may be desired in some embodiments to facilitate filling the bulb at or below atmospheric pressure. In particular embodiments, pressures between 400 Torr and 600 Torr are used to enhance starting. Example high pressure fills may also include metal halide and Mercury which have a relatively low vapor pressure at room temperature. An ignition enhancer such as Kr₈₅ may also be used. In a particular example, the fill includes 1.608 mg Mercury, 0.1 mg Indium Bromide and about 10 nanoCurie of Kr₈₅. In this example, Argon or Krypton is provided at a pressure in the range of about 400 Torr to 760 Torr, depending upon desired startup characteristics. Initial breakdown of the noble gas is more difficult at higher pressure, but the overall warm up time required for the fill to fully vaporize and reach peak brightness is reduced. The above pressures are measured at 22° C. (room temperature). It is understood that much higher pressures are achieved at operating temperatures after the plasma is formed. The above pressures are measured at 22° C. (room temperature). It is understood that much higher pressures are achieved at operating temperatures after the plasma is formed (e.g., greater than 2 atmospheres and 10-100 atmospheres or more in example embodiments or any range subsumed therein). These pressures and fills are examples only and other pressures and fills may be used in other embodiments.

A layer of material 116 may be placed between the bulb 104 and the dielectric material of lamp body 102. In example embodiments, the layer of material 116 may have a lower thermal conductivity than the lamp body 102 and may be used to optimize thermal conductivity between the bulb 104 and the lamp body 102. In an example embodiment, the layer 116 may have a thermal conductivity in the range of about 0.5 to 10 watts/meter-Kelvin (W/mK) or any range subsumed therein. For example, alumina powder with 55% packing density (45% fractional porosity) and thermal conductivity in a range of about 1 to 2 watts/meter-Kelvin (W/mK) may be used. In some embodiments, a centrifuge may be used to pack the alumina powder with high density. In an example embodiment, a layer of alumina powder is used with a thickness D5 within the range of about ⅛ mm to 1 mm or any range subsumed therein. Alternatively, a thin layer of a ceramic-based adhesive or an admixture of such adhesives may be used. Depending on the formulation, a wide range of thermal conductivities is available. In practice, once a layer composition is selected having a thermal conductivity close to the desired value, fine-tuning may be accomplished by altering the layer thickness. Some example embodiments may not include a separate layer of material around the bulb and may provide a direct conductive path to the lamp body. Alternatively, the bulb may be separated from the lamp body by an air-gap (or other gas filled gap) or vacuum gap.

In some example embodiments, alumina powder or other material may also be packed into a recess 118 formed below the bulb 104. In the example shown in FIG. 1A, the alumina powder in the recess 118 is outside the boundaries of the waveguide formed by the electrically conductive material 108 on the surfaces of the lamp body 102. The material in the recess 118 provides structural support, reflects light from the bulb and provides thermal conduction. One or more heat sinks may also be used around the sides and/or along the bottom surface of the lamp body to manage temperature. Thermal modeling may be used to help select a lamp configuration providing a high peak plasma temperature resulting in high brightness, while remaining below the working temperature of the bulb material. Example thermal modeling software includes the TAS software package available commercially from Harvard Thermal, Inc. of Harvard, Mass.

Lamp 100 has a drive probe 120 inserted into the lamp body 102 to provide radio frequency power to the lamp body 102. In the example of FIG. 1A, the lamp also has a feedback probe 122 inserted into the lamp body 102 to sample power from the lamp body 102 and provide it as feedback to the lamp drive circuit 106. In an example embodiment, the drive probe 120 is positioned closer to the bulb in the center of the lamp body than the electrically conductive material 108 around the outer circumference of the lamp body 102. This positioning of the drive prove 120 can be used to improve coupling of power to the plasma in the bulb 104.

A lamp drive circuit 106 including a power supply, such as amplifier 124, may be coupled to the drive probe 120 to provide the radio frequency power. The amplifier 124 may be coupled to the drive probe 120 through a matching network 126 to provide impedance matching. In an example embodiment, the lamp drive circuit 106 is matched to the load (formed by the lamp body, bulb and plasma) for the steady state operating conditions of the lamp. The lamp drive circuit 106 is matched to the load at the drive probe 120 using the matching network 126.

A high efficiency amplifier may have some unstable regions of operation. The amplifier 124 and phase shift imposed by the feedback loop of the lamp circuit 106 should be configured so that the amplifier operates in stable regions even as the load condition of the lamp changes. The phase shift imposed by the feedback loop is determined by the length of the loop (including matching network 126) and any phase shift imposed by circuit elements such as a phase shifter 130. At initial startup before the noble gas in the bulb is ignited, the load appears to the amplifier as an open circuit. The load characteristics change as the noble gas ignites, the fill vaporizes and the plasma heats up to steady state operating conditions. The amplifier and feedback loop are designed so the amplifier will operate within stable regions across the load conditions that may be presented by the lamp body, bulb and plasma. The amplifier 124 may include impedance matching elements such as resistive, capacitive and inductive circuit elements in series and/or in parallel. Similar elements may be used in the matching network. In one example embodiment, the matching network is formed from a selected length of pcb trace that is included in the lamp drive circuit between the amplifier 124 and the drive probe 120. These elements are selected both for impedance matching and to provide a phase shift in the feedback loop that keeps the amplifier within stable regions of its operation. A phase shifter 130 may be used to provide additional phase shifting as needed to keep the amplifier in stable regions.

The amplifier 124 and phase shift in the feedback loop may be designed by looking at the reflection coefficient Γ, which is a measure of the changing load condition over the various phases of lamp operation, particularly the transition from cold gas at start-up to hot plasma at steady state. F, defined with respect to a reference plane at the amplifier output, is the ratio of the “reflected” electric field Eᵢₙ heading into the amplifier, to the “outgoing” electric field Eₒᵤₜ traveling out. Being a ratio of fields, F is a complex number with a magnitude and phase. A useful way to depict changing conditions in a system is to use a “polar-chart” plot of Γ's behavior (termed a “load trajectory”) on the complex plane. Certain regions of the polar chart may represent unstable regions of operation for the amplifier 124. The amplifier 124 and phase shift in the feedback loop should be designed so the load trajectory does not cross an unstable region. The load trajectory can be rotated on the polar chart by changing the phase shift of the feedback loop (by using the phase shifter 130 and/or adjusting the length of the circuit loop formed by the lamp drive circuit to the extent permitted while maintaining the desired impedance matching). The load trajectory can be shifted radially by changing the magnitude (e.g., by using an attenuator).

In example embodiments, the amplifier 124 may be operated in multiple operating modes at different bias conditions to improve starting and then to improve overall amplifier efficiency during steady state operation. For example, the amplifier may be biased to operate in Class A/B mode to provide better dynamic range during startup and in Class C mode during steady state operation to provide more efficiency. The amplifier may also have a gain control that can be used to adjust the gain of the amplifier 124. Amplifier 124 may include either a plurality of gain stages or a single stage.

The feedback probe 122 is coupled to the input of the amplifier 124 through an attenuator 128 and phase shifter 130. The attenuator 128 is used to adjust the power of the feedback signal to an appropriate level for input to the phase shifter 130. In some embodiments, a second attenuator may be used between the phase shifter 130 and the amplifier 124 to adjust the power of the signal to an appropriate level for amplification by the amplifier 124. In some embodiments, the attenuator(s) may be variable attenuators controlled by the control electronics 132. In other embodiments, the attenuators may be set to a fixed value. In some embodiments, the lamp drive circuit may not include an attenuator. In an example embodiment, the phase shifter 130 may be a voltage-controlled phase shifter controlled by the control electronics 132.

The feedback loop automatically oscillates at a frequency based on the load conditions and phase of the feedback signal. This feedback loop may be used to maintain a resonant condition in the lamp body 102 even though the load conditions change as the plasma is ignited and the temperature of the lamp changes. If the phase is such that constructive interference occurs for waves of a particular frequency circulating through the loop, and if the total response of the loop (including the amplifier, lamp, and all connecting elements) at that frequency is such that the wave is amplified rather than attenuated after traversing the loop, the loop will oscillate at that frequency. Whether a particular setting of the phase-shifter induces constructive or destructive feedback depends on frequency. The phase-shifter 128 can be used to finely tune the frequency of oscillation within the range supported by the lamp's frequency response. In doing so, it also effectively tunes how well RF power is coupled into the lamp because power absorption is frequency-dependent. Thus, the phase-shifter 128 provides fast, finely-tunable control of the lamp output intensity. Both tuning and detuning are useful. For example: tuning can be used to maximize intensity as component aging changes the overall loop phase; detuning can be used to control lamp dimming. In some example embodiments, the phase selected for steady state operation may be slightly out of resonance, so maximum brightness is not achieved. This may be used to leave room for the brightness to be increased and/or decreased by control electronics 130.

In FIG. 1A, control electronics 132 is connected to attenuator 128, phase shifter 130 and amplifier 124. The control electronics 132 provide signals to adjust the level of attenuation provided by the attenuator 128, phase of phase shifter 130, the class in which the amplifier 124 operates (e.g., Class A/B, Class B or Class C mode) and/or the gain of the amplifier 124 to control the power provided to the lamp body 102. In one example, the amplifier 124 has three stages, a pre-driver stage, a driver stage and an output stage, and the control electronics 132 provides a separate signal to each stage (drain voltage for the pre-driver stage and gate bias voltage of the driver stage and the output stage). The drain voltage of the pre-driver stage can be adjusted to adjust the gain of the amplifier. The gate bias of the driver stage can be used to turn on or turn off the amplifier. The gate bias of the output stage can be used to choose the operating mode of the amplifier (e.g., Class A/B, Class B or Class C). Control electronics 130 can range from a simple analog feedback circuit to a microprocessor/microcontroller with embedded software or firmware that controls the operation of the lamp drive circuit. The control electronics 130 may include a lookup table or other memory that contains control parameters (e.g., amount of phase shift or amplifier gain) to be used when certain operating conditions are detected. In example embodiments, feedback information regarding the lamp's light output intensity is provided either directly by an optical sensor 134, e.g., a silicon photodiode sensitive in the visible wavelengths, or indirectly by an RF power sensor 136, e.g., a rectifier. The RF power sensor 136 may be used to determine forward power, reflected power or net power at the drive probe 120 to determine the operating status of the lamp. A directional coupler may be used to tap a small portion of the power and feed it to the RF power sensor 136. An RF power sensor may also be coupled to the lamp drive circuit at the feedback probe 122 to detect transmitted power for this purpose. In some embodiments, the control electronics 132 may adjust the phase shifter 130 on an ongoing basis to automatically maintain desired operating conditions.

High frequency simulation software may be used to help select the materials and shape of the lamp body and electrically conductive coating to achieve desired resonant frequencies and field intensity distribution in the lamp body. Simulations may be performed using software tools such as HFSS, available from Ansoft, Inc. of Pittsburgh, Pa., and FEMLAB, available from COMSOL, Inc. of Burlington, Mass. to determine the desired shape of the lamp body, resonant frequencies and field intensity distribution. The desired properties may then be fine-tuned empirically.

While a variety of materials, shapes and frequencies may be used, one example embodiment has a lamp body 102 designed to operate in a fundamental TM resonant mode at a frequency of about 880 MHz (although the resonant frequency changes as lamp operating conditions change as described further below). In this example, the lamp has an alumina lamp body 102 with a relative permittivity of 9.2. The lamp body 102 has a cylindrical outer surface as shown in FIG. 1B with a recess 118 formed in the bottom surface. In an alternative embodiment shown in FIG. 1C, the lamp body 102 may have a rectangular outer surface. The outer diameter D1 of the lamp body 102 in FIG. 1B is about 40.75 mm and the diameter D2 of the recess 118 is about 8 mm. The lamp body has a height H1 of about 17 mm. A narrow region 112 forms a shelf over the recess 118. The thickness H2 of the narrow region 112 is about 2 mm. As shown in FIG. 1A, in this region of the lamp body 102 the electrically conductive surfaces on the lamp body are only separated by the thin region 112 of the shelf. This results in higher capacitance in this region of the lamp body and higher electric field intensities. This shape has been found to support a lower resonant frequency than a solid cylindrical body having the same overall diameter D1 and height H1 or a solid rectangular body having the same overall width and height. For example, in some embodiments, the relative permittivity is in the range of about 9-15 or any range subsumed therein, the frequency of the RF power is less than about 1 GHz and the volume of the lamp body is in the range of about 10 cm³ to 30 cm³ or any range subsumed therein.

In this example, a hole 110 is formed in the thin region 112. The hole has a diameter of about 5.5 mm and the bulb has an outer diameter of about 5 mm. The shelf formed by the thin region 112 extends radially from the edge of the hole 110 by a distance D3 of about 1.25 mm. Alumina powder is packed between the bulb and the lamp body and forms a layer having a thickness D5 of about ¼ mm. The bulb 104 has an outer length of about 15 mm and an interior length of about 9 mm. The interior diameter at the center is about 2.2 mm and the side walls have a thickness of about 1.4 mm. The bulb protrudes from the front surface of the lamp body by about 4.7 mm. The bulb has a high pressure fill of Argon, Kr₈₅, Mercury and Indium Bromide as described above. At pressures above 400 Torr, a sparker or other ignition aid may be used for initial ignition. Aging of the bulb may facilitate fill breakdown, and the fill may ignite without a separate ignition aid after burn-in of about 72 hours.

In this example, the drive probe 120 is about 15 mm long with a diameter of about 2 mm. The drive probe 120 is about 7 mm from the central axis of the lamp body and a distance D4 of about 3 mm from the electrically conductive material 108 on the inside surface of recess 118. The relatively short distance from the drive probe 120 to the bulb 104 enhances coupling of power. The feedback probe 122 is a distance D6 of about 11 mm from the electrically conductive material 108. In one example, a 15 mm hole is drilled for the feedback probe 122 to allow the length and coupling to be adjusted. The unused portion of the hole may be filled with PTFE (Teflon) or another material. In this example, the feedback probe 122 has a length of about 3 mm and a diameter of about 2 mm. In another embodiment where the length of the hole matches the length of the feedback probe 122, the length of the feedback probe 122 is about 1.5 mm.

In this example, the lamp drive circuit 106 includes an attenuator 128, phase shifter 130, amplifier 124, matching network 126 and control electronics 132 such as a microprocessor or microcontroller that controls the drive circuit. A sensor 134 detects the intensity of light emitted by the bulb 104 and provides this information to the control electronics 132 to control the drive circuit 132. In an alternative embodiment, an RF power sensor 136 may be used to detect forward, reflected or net power to be used by the control electronics to control the drive circuit.

The power to the lamp body 102 may be controlled to provide a desired startup sequence for igniting the plasma. As the plasma ignites and heats up during the startup process, the impedance and operating conditions of the lamp change. In order to provide for efficient power coupling during steady state operation of the lamp, the lamp drive circuit 106 is impedance matched to the steady state load of the lamp body, bulb and plasma after the plasma is ignited and reaches steady state operating conditions. This allows power to be critically coupled from the drive circuit 106 to the lamp body 102 during steady state operation. However, the power from the drive circuit 106 is overcoupled to the lamp body 102 at startup. As a result, much of the power from the drive circuit 106 is reflected when the lamp is initially turned on. For example, the amplifier 124 may provide about 170 watts of forward power, but more than half of this power may be reflected at startup. The net power to the lamp may be only between about 40-80 watts when the power is initially turned on, and the rest may be reflected.

In one example startup procedure, the lamp 100 starts at a frequency of about 895 MHz and the Argon ignites almost immediately. Upon ignition, the frequency drops to about 880 MHz due to the change in impedance from the ignition of the Argon. The Mercury then vaporizes and heats up. The Indium Bromide also vaporizes and light is emitted at full brightness. When this light is detected by sensor 134, the phase shifter 130 is adjusted to accommodate for the change in frequency due to the change in the impedance of the plasma. With the appropriate phase shift, the feedback loop adjusts the frequency to about 885 MHz. In an example embodiment, when this startup process is used with a high pressure fill as described above, the startup process from power on to full vaporization of the fill may be completed in about 5-10 seconds or less. As a result, full brightness can be achieved very rapidly.

As the plasma continues to heat up, the impedance continues to change and the frequency continues to drop until the lamp reaches steady state operating conditions. As the frequency changes, the phase of the phase shifter 130 may continue to be adjusted to match the changes in frequency. In an example startup procedure, the frequency ramps down to a steady state operating frequency of about 877 MHz. This ramp may take several minutes. In order to avoid a drop in brightness, the control electronics 132 adjusts the phase of the phase shifter 130 in stages to match the ramp. A lookup table in the control electronics 132 may be used to store a sequence of parameters indicating the amount of phase shift to be used by the control electronics 132 during the ramp. In one example, the voltage to be applied to the phase shifter is stored in the lookup table for startup (ignition), full brightness of the plasma (light mode) and steady state after the lamp is heated (run mode). The control electronics may use these parameters to shift the phase in increments between full vaporization of the fill and completion of heat up. In one example, the lookup table may linearly interpolate between the desired phase at full vaporization (light mode) when the frequency is about 885 MHz and the desired phase at the end of heat up (run mode) when the frequency is about 877 MHz. In one example, firmware in the control electronics linearly interpolates sixteen values for the phase voltage that are applied in equal increments over a period of about 5 minutes as the lamp ramps from light mode to run mode. The phase adjustments and ramp may be determined empirically and programmed into the lookup table based on the operating conditions of the particular lamp. In an alternative embodiment, the control electronics 132 may automatically shift the phase periodically to determine whether a change in one direction or another results in more efficient power coupling and/or higher brightness (based on feedback from an optical sensor or RF power sensor in the drive circuit). This periodic phase shift can be performed very rapidly, so an observer does not notice any visible change in the light output intensity.

The phase of the phase shifter 130 and/or gain of the amplifier 124 may also be adjusted after startup to change the operating conditions of the lamp. For example, the power input to the plasma in the bulb 104 may be modulated to modulate the intensity of light emitted by the plasma. This can be used for brightness lock to maintain a constant brightness even if components age. This can also be used for brightness adjustment. If the lamp is not operating at resonance for peak brightness, the phase may be shifted to increase brightness. The phase may also be shifted to dim the lamp. In some embodiments, the lamp may be adjusted to 20% to 100% of peak brightness, or any range subsumed therein, while maintaining continuous supply of power to the lamp and without extinguishing the plasma discharge. In some embodiments, this may be accomplished by changing the phase shift without changing the voltage level that controls the gain of the amplifier. In other embodiments, the gain of the amplifier may also be adjusted. The light output intensity of the lamp may also be modulated to adjust for video effects in a projection display. For example, a projection display system may use a microdisplay that controls intensity of the projected image using pulse-width modulation (PWM). PWM achieves proportional modulation of the intensity of any particular pixel by controlling, for each displayed frame, the fraction of time spent in either the “ON” or “OFF” state. By reducing the brightness of the lamp during dark frames of video, a larger range of PWM values may be used to distinguish shades within the frame of video. The brightness of the lamp may also be modulated during particular color segments of a color wheel for color balancing or to compensate for green snow effect in dark scenes by reducing the brightness of the lamp during the green segment of the color wheel.

In another example, the phase shifter 130 can be modulated to spread the power provided by the lamp circuit 106 over a larger bandwidth. This can reduce ElectroMagnetic Interference (EMI) at any one frequency and thereby help with compliance with FCC regulations regarding EMI. In example embodiments, the degree of spectral spreading may be from 5-30% or any range subsumed therein. In one example, the control electronics 132 may include circuitry to generate a sawtooth voltage signal and sum it with the control voltage signal to be applied to the phase shifter 130. In another example, the control electronics 132 may include a microcontroller that generates a Pulse Width Modulated (PWM) signal that is passed through an external low-pass filter to generate a modulated control voltage signal to be applied to the phase shifter 130. In example embodiments, the modulation of the phase shifter 130 can be provided at a level that is effective in reducing EMI without any significant impact on the plasma in the bulb.

In example embodiments, the amplifier 124 may also be operated at different bias conditions during different modes of operation for the lamp. The bias condition of the amplifier 124 has a large impact on DC-RF efficiency. For example, an amplifier biased to operate in Class C mode is more efficient than an amplifier biased to operate in Class B mode, which in turn is more efficient than an amplifier biased to operate in Class A/B mode. However, an amplifier biased to operate in Class A/B mode has a better dynamic range than an amplifier biased to operate in Class B mode, which in turn has better dynamic range than an amplifier biased to operate in Class C mode.

In one example, when the lamp is first turned on, amplifier 124 is biased in a Class A/B mode. Class A/B provides better dynamic range and more gain to allow amplifier 124 to ignite the plasma and to follow the resonant frequency of the lamp as it adjusts during startup. Once the lamp reaches full brightness, amplifier bias is removed which puts amplifier 124 into a Class C mode. This provides improved efficiency. However, the dynamic range in Class C mode may not be sufficient when the brightness of the lamp is modulated below a certain level (e.g., less than 70% of full brightness). When the brightness is lowered below the threshold, the amplifier 124 may be changed back to Class A/B mode. Alternatively, Class B mode may be used in some embodiments. The above dimensions, shape, materials and operating parameters are examples only and other embodiments may use different dimensions, shape, materials and operating parameters.

1-36. (canceled)

37. An electrodeless plasma lamp comprising:
a lamp body;
a bulb proximate to the lamp body;
a lamp drive circuit;
a circuit board including at least a portion of the lamp drive circuit; and
an RF feed coupled to the circuit board and extending into the lamp body, wherein a plane defined by the circuit board intersects the lamp body.

38. The electrodeless plasma lamp of claim 37, wherein the plane substantially bisects the lamp body.

39. The electrodeless plasma lamp of claim 37, wherein the lamp body comprises a solid dielectric material.

40. The electrodeless plasma lamp of claim 37, wherein the RF feed is parallel to the plane of the circuit board.

41. The electrodeless plasma lamp of claim 37, wherein the RF feed extends past the edge of the circuit board into the lamp body.

42. The electrodeless plasma lamp of claim 37, wherein
the lamp body comprises a dielectric material having a relative permittivity greater than 2; and
the lamp drive circuit is configured to couple power into the lamp body through the RF feed at a frequency that forms a standing wave within the lamp body.

43. The electrodeless plasma lamp of claim 37, wherein
the lamp body comprises a dielectric material having a relative permittivity greater than 2; and
the lamp drive circuit is configured to couple power into the lamp body through the RF feed at a frequency within the resonant bandwidth of a resonant mode for the lamp body.

44. The electrodeless plasma lamp of claim 43, wherein the resonant mode is the fundamental resonant mode for the lamp body.

45. The electrodeless plasma lamp of claim 43, wherein the RF feed comprises a trace on the circuit board.

46. The electrodeless plasma lamp of claim 37, wherein the RF feed comprises a trace on the circuit board.

47. The electrodeless plasma lamp of claim 37, further comprising a second RF feed coupled to the circuit board and extending into the lamp body.

48. The electrodeless plasma lamp of claim 47, wherein the second RF feed is a feedback probe.

49. The electrodeless plasma lamp of claim 37, further comprising a second RF feed extending into the lamp body, wherein the second RF feed comprises a trace on the circuit board.

50. An electrodeless plasma lamp comprising:
a lamp body;
a bulb proximate the lamp body;
a lamp drive circuit;
a circuit board containing at least a portion of the lamp drive circuit; and
a portion of the circuit board extending into the lamp body and forming an RF feed for coupling power from the lamp drive circuit into the lamp body.

51. The electrodeless plasma lamp of claim 50, further comprising a second portion of the circuit board extending into the lamp body and forming a second RF feed.

52. The electrodeless plasma lamp of claim 51, wherein the second RF feed obtains feedback from the lamp body and provides the feedback to the lamp drive circuit.

53. The electrodeless plasma lamp of claim 50, wherein
the lamp body comprises a dielectric material having a relative permittivity greater than 2; and
the lamp drive circuit is configured to couple power into the lamp body through the RF feed at a frequency that forms a standing wave within the lamp body.

54. The electrodeless plasma lamp of claim 50, wherein
the lamp body comprises a dielectric material having a relative permittivity greater than 2; and
the lamp drive circuit is configured to couple power into the lamp body through the RF feed at a frequency within the resonant bandwidth of a resonant mode for the lamp body.

55. The electrodeless plasma lamp of claim 54, wherein the resonant mode is the fundamental resonant mode for the lamp body.

56. The electrodeless plasma lamp of claim 50, wherein the lamp body comprises a solid dielectric material and the portion of the circuit board extends into an opening formed in the solid dielectric material.

57. The electrodeless plasma lamp of claim 50, wherein the RF feed is a linear probe.

58. The electrodeless plasma lamp of claim 50, wherein:
the lamp body provides a resonant structure comprising the solid dielectric material and an electrically conductive material; and
the RF feed configured to couple power from the drive circuit to the resonant structure at a frequency that is within the resonant bandwidth of the resonant structure.
